(19) United States
(12) Patent Application Publication
(10) Pub. No.: US 2007/0109603 A1
(43) Pub. Date: May 17, 2007

(54) PRINTING APPARATUS, PRINTING APPARATUS CONTROL PROGRAM, PRINTING APPARATUS CONTROL METHOD, IMAGE PROCESSING DEVICE, IMAGE PROCESSING PROGRAM, IMAGE PROCESSING METHOD, AND RECORDING MEDIUM HAVING THE PROGRAM RECORDED THEREON

(75) Inventor: Hiroaki SAKAI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/558,653

(22) Filed: Nov. 10, 2006

(30) Foreign Application Priority Data
Nov. 11, 2005 (JP) 2005-327056
Aug. 18, 2006 (JP) 2006-223092

(51) Int. Cl. H04N 1/405

(52) U.S. Cl. 358/3.13

(57) ABSTRACT

An apparatus is provided that prints on a printing medium while a head having nozzles that discharge ink moves relative to the printing medium. The apparatus includes a unit capturing image data to be a target of N-valued processing (N is a natural number of N≧2), a unit capturing input/output characteristics information showing the correspondence between input image data (before N-valued processing for every line), and output image data (image data after each piece of the input image data is subjected to N-valued processing), a unit correcting the image data before N-valued processing based on the acquired input/output characteristics information, a unit performing N-valued processing on the corrected image data, a unit converting the N-valued processed image data into printing data, and a unit executing printing based on the printing data.

### RELATED APPLICATIONS

This application claims priority to Japanese Patent Application Nos. 2005-327056 filed Nov. 11, 2005 and 2006-223092 filed Aug. 18, 2006 which are hereby expressly incorporated by reference herein in their entirety.

### BACKGROUND

1. Technical Field

The present invention relates to a printing apparatus that corrects image data to be a target of printing based on the correspondence of the image data for each line between the image data before N-valued processing and the image data after N-valued processing, a printing apparatus control program, a printing apparatus control method, an image processing device, an image processing program, an image processing method, and a recording medium having the program recorded thereon.

2. Related Art

In an ink-jet printer, a head that discharges ink has a plurality of nozzles in order to realize high-speed printing, and performs printing with the plurality of nozzles by discharging ink from each nozzle while the head and a printing medium move relative to each other. Further, as for image processing of the printer, image data to be a target of printing is subjected to N-valued processing using an error diffusion method or a dither method in order to improve the dispersibility of dots to be discharged from the head.

In the related art, a dispersive dither matrix is designed in consideration of typically visual features. However, as shown in FIG. 11, a mask resultant value for every line is different. For example, in an example shown in FIG. 11, the mask sum value for every line is different such that the sums for horizontal lines of the dither matrix are 20, 36, 24, and 40 from an upper part of the sheet toward a lower part thereof, and the sums for vertical lines of the dither matrix are 22, 38, 22, and 38 from the left of the sheet toward the right thereof.

If the mask sum values are different in this manner, a dot appearance rate becomes different. Therefore, when a certain solid image is input, output luminance for every line becomes different.

In particular, many ink-jet printers known as line head printers have a structure in which the head is fixed, and the paper moves, and have the same head size as the width of the paper. Since the line head printer finishes printing processing by single scanning, very high-speed printing is possible. However, it is very difficult to uniformly tune the characteristics of a plurality of nozzles possessed by the head. Generally, there is a variation between nozzles. This variation includes a variation in ink discharge amount in that the discharge amount of ink for every nozzle is different, and a variation in the landing position in that the landing position of dots is different from an ideal position due to a phenomenon called flight bending. Since the variations cause the same printing results to be obtained even if printing is performed on some copies, there is reproducibility in the variations. Accordingly, even though it is necessary to output a proper image by single scanning, there is a problem in that a dot landing position deviates due to discharge unevenness in the ink to be discharged from each nozzle or flight bending of the nozzles, and consequently an image markedly deteriorates. Accordingly, a density correction method as disclosed in JP-A-05-092559 is suggested.

The density correction method is realized by a recording apparatus including: a driving unit that drives a plurality of recording elements based on recording data for which recording data of recording elements other than a recording element concerned is taken into consideration; a reading unit that reads information recorded on a recording medium, by driving of the driving unit; a correction value calculating unit that calculates a correction value related to each of the plurality of recording elements based on the data read by the reading unit, and considers calculation of correction values of recording elements other than a recording element concerned in response to consideration of the recording data of the recording elements other than the recording element concerned during the above calculation; and a correcting unit that corrects the recording data in the driving unit based on the correction value calculated by the correction calculating unit.

Further, JP-A-08-18787 suggests an image forming apparatus that performs multi-valued dither processing on image signals input from outside, and display gray-scale by multi-valued data obtained by the multi-valued dither processing. The image forming apparatus is provided with a λ characteristics table having at least two density correction curves corresponding to λ characteristics of each dot of a multi-valued dither matrix that performs the multi-valued dither processing.

However, in the above-described JP-A-05-092559 and JP-A-08-18787, the density after printing is kept uniform by raising or lowering the density units of the nozzles. In this case, if the density for every line before and after multi-valued processing becomes different, there is a fear that the density correction before multi-valued processing is performed does not function well, which may have a bad effect on printing results.

Further, when an image, such as a gradation image in which gray-scale changes stepwise, is printed, there is a case that a density difference for every line before and after N-valued processing has a bad effect on printing results, which may cause reversal of the gray-scale.

### SUMMARY

An advantage of some aspects of the invention is to provide a printing apparatus that is suitable for eliminating deterioration of a printed image due to a density difference for every line before and after multi-valued processing, a printing apparatus control program, a printing apparatus control method, an image processing device, an image processing program, an image processing method, and a recording medium having the program recorded thereon.

Aspect 1

According to Aspect 1 of the invention, there is provided a printing apparatus that performs printing on a printing medium while a head having a plurality of nozzles that discharge ink and the printing medium move relative to each other, The printing apparatus includes: an image capturing unit that acquires image data to be a target of N-valued processing (N is a natural number of N≧2); an input/output characteristics information capturing unit that acquires Input/output characteristics information showing the correspondence between input image data that is image data before N-valued processing for every liner and output image data that is image data after each piece of the input image data has been subjected to N-valued processing; an image correcting unit that corrects the image data before N-valued processing based on the input/output characteristics information acquired by the input/output characteristics information capturing unit; an N-valued processing unit that performs N-valued processing on the image data corrected by the image correcting unit; a printing data creating unit that converts the image data that has been subjected to N-valued processing by the N-valued processing unit into printing data; and a printing unit that executes printing based on the printing data.

According to this configuration, the input/output characteristics information capturing unit can acquire the input/output characteristics information, and the image correcting unit can obtain an optimal pixel value (for example, an optimal average pixel value for every line) of image data before N-valued processing based on the input/output characteristics information, and can correct the image data based on the optimal pixel value. As a result, it is possible to provide a clearer image than the image before the correction.

Here, the above ‘printing medium’ is a medium serving as a printing target, such as printing paper (including a card) or a CDR or a DVDR on the surface of which printing is enabled. Besides, the printing medium may be any printable medium. This is the same in the following aspects including an aspect of a printing apparatus, an aspect of a printing apparatus control program, an aspect of a printing apparatus control method, an aspect of an image processing device, an aspect of an image processing program, an aspect of an image processing method, and an aspect of a recording medium having the program recorded thereon.

Further, the above ‘image capturing unit’ may be any configuration if it is adapted to acquire image data. For example, the image capturing unit may be adapted to input image data from an input device or the like, may be adapted to obtain or receive image data from an external device or the like, may be adapted to read image data from an internal storage, a detachable storage, or the like. Accordingly, the acquisition includes at least input, obtention, reception, and reading. This is the same in the following aspects including an aspect of a printing apparatus, an aspect of a printing apparatus control program, an aspect of a printing apparatus control method, an aspect of an image processing device, an aspect of an image processing program, an aspect of an image processing method, and an aspect of a recording medium having the program recorded thereon.

Further, the above ‘input/output characteristics information’ is information showing the correspondence between pixel values (input image data) of image data before N-valued processing and pixel values (output image data) after the pixel values (input image data) have been subjected to N-valued processing, according to categories/kinds (error diffusion method, a dither method and the like) of the N-valued processing technique, and contents (values such as thresholds in each technique). For example, a data table that enables the pixel values (input image data) before N-valued processing to be known from the pixel values after N-valued processing (output image data) or that enables the pixel values after N-valued processing to be known from the pixel values before N-valued processing falls under category of the ‘input/output characteristics information. In addition, if the kind of the N-valued processing technique is, for example, a dither method, a pixel value (output image data) after N-valued processing can be found from each threshold of a dither mask. For example, a pixel value for every line after N-valued processing can be found from a line sum value or a line average value of the dither mask. In this case, as the input/output characteristics information, for example, a line characteristics table will be created. This is the same in the following aspects including an aspect of a printing apparatus, an aspect of a printing apparatus control program, an aspect of a printing apparatus control method, an aspect of an image processing device, an aspect of an image processing program, an aspect of an image processing method, and an aspect of a recording medium having the program recorded thereon.

Further, the above ‘image correcting unit’ makes a correction to reduce or eliminate a difference value between a pixel value before N-valued processing and the pixel value after N-valued processing to the pixel value before N-valued processing in order to reduce deterioration of printing quality caused by an increase of the difference value. For example, the image correcting unit changes the value before N-valued processing according to characteristics of an N-valued processing technique so that the pixel value before N-valued processing may become the pixel value after N-valued processing. This is the same in the following aspects including an aspect of a printing apparatus, an aspect of a printing apparatus control program, an aspect of a printing apparatus control method, an aspect of an image processing device, an aspect of an image processing program, an aspect of an image processing method, and an aspect of a recording medium having the program recorded thereon.

Aspect 2

The printing apparatus of Aspect 2 is a printing apparatus according to Aspect 1 in which the input/output characteristics information is an N-valued input/output characteristics table that is a data table showing the correspondence between the input image data for every line and the output image data for every line, with respect to predetermined image data, and the input/output characteristics information capturing unit creates the N-valued input/output characteristics table with respect to the image data acquired by the image capturing unit.

According to this configuration, since the input/output characteristics information capturing unit can acquire or generate an N-valued input/output characteristics table showing the correspondence between output image data (for example, an average pixel value or the like) for every line after N-valued processing and input image data (for example, an average density value, an average luminance value or the like) for every line before N-valued processing, and the image correcting unit can find out optimal input image data (for example, an average pixel value for every line or the like) referring to the N-valued input/output characteristics table, it is possible to provide an image that is cleaner than the image before correction.

Here, an average density value, an average luminance value, and the like fall under the category of the above ‘average pixel value.’ This is the same in the following aspects including an aspect of a printing apparatus, an aspect of a printing apparatus control program, an aspect of a printing apparatus control method, an aspect of an image processing device, an aspect of an image processing program, an aspect of an image processing method, and an aspect of a recording medium having the program recorded thereon.

Aspect 3

The printing apparatus of Aspect 3 is a printing apparatus according to Aspect 2 in which the N-valued input/output characteristics table is configured from the input image data and the output image data when, with respect to solid image data for every predetermined gray-scale level, an average pixel value for every line of each piece of the solid image data after N-valued processing is used as the output image data, and an average pixel value for every line before N-valued processing of each piece of the solid image data is used as the input image data.

According to this configuration, since the N-valued input/output characteristics table is configured, with respect to solid image data for every predetermined gray-scale level, using an average pixel value for every line after N-valued processing as the output image data and using an average pixel value for every line before N-valued processing as the input image data, the image correcting unit can find out an optimal line average pixel value for every predetermined gray-scale level, referring to the N-valued input/output characteristics table. As a result, since it is possible to alleviate the influence of a density difference for every line before and after N-valued processing for every predetermined gray-scale level, it is possible to alleviate a bad effect on printing quality that is caused by a density difference before and after N-valued processing, such as reversal of gray-scale in a gradation image or the like.

Aspect 4

The printing apparatus of Aspect 4 is a printing apparatus according to Aspect 3 in which the average pixel value after N-valued processing for every line is an average value of pixel values corresponding to pixels that form a line of an image after N-valued processing, in a dot printing direction of the nozzles of the head.

According to this configuration, since the correcting unit can find out the average pixel value of a line in a dot printing direction of the nozzles of the head as an optimal average pixel value for every line, it is possible to eliminate a density difference before and after N-valued processing in each line in a direction in which banding (deep streak or thin streak) is apt to occur. Thus, it is possible to alleviate a bad effect on printing quality caused by the density difference.

Here, the above ‘dot’ means one region where ink discharged from one nozzle or a plurality of nozzles lands on a printing medium. Further, plural kinds of “dots” exist for every size as well as dots having a certain size (area) instead of “zero” but exist. Here, the shape of dots formed by discharging ink is not necessarily limited to a true circular shape. For example, in a case where dots are formed into shapes other than the true circular shape, such as an elliptical shape, the average diameter of the dot is treated as a dot diameter, or assuming the equivalent dot having the same diameter as the area of a dot formed by discharging a certain amount of ink, the diameter of the equivalent dot is treated as a dot diameter. Further, as a method of separately shooting dots having different densities, for example, a method of shooting dots having the same dot size and different densities, a method of shooting dots having the same density and different sizes, a method of making the density of dots different by overlap-shooting dots having the same density and different discharge amounts, and the like are conceivable. Further, even in a case where one ink droplet discharged from one nozzle lands as split pieces, this ink droplet is considered to be one dot. However, in a case where two or more dots formed by discharging ink from two nozzles or discharging ink at time intervals from one nozzles stick, it is considered that two dots are formed. This is the same in the following aspects including an aspect of a printing apparatus, an aspect of a printing apparatus control program, an aspect of a printing apparatus control method, an aspect of an image processing device, an aspect of an image processing program, an aspect of an image processing method, and an aspect of a recording medium having the program recorded thereon.

Aspect 5

The printing apparatus of Aspects 5 is a printing apparatus according to any one of Aspects 2 to 4 in which the image correcting unit uses image data of a target pixel of an image to be corrected as desired output image data, extracts input image data corresponding to the desired output image data from the N-valued input/output characteristics table and changes the image data of target pixels into the extracted input image data.

According to this configuration, since image data of a target pixel of an image to be corrected is used as desired output image data, input image data corresponding to output image data that becomes the same pixel value (or a value nearest thereto) as the desired output image data can be extracted from the N-valued input/output characteristics table to change the image data of target pixels to a pixel value indicated by the input image data. As a result, since a density difference before and after N-valued processing can be cancelled properly, it is possible to further alleviate a bad influence on printing quality caused by the density difference.

Aspect 6

The printing apparatus of Aspects 6 is a printing apparatus according to any one of Aspects 1 to 5 in which the image data of an image to be corrected that is acquired by the image capturing unit is image data after the density of the image data is corrected.

According to this configuration, since a corrected image after being corrected using various correcting methods is used, more optimal input image data (average pixel value for every line) can be found out. As a result, since the corrected image can be reproduced with high fidelity, a better image can be output.

Aspect 7

According to Aspects 7 of the invention, there is provided a printing apparatus control program that controls a printing apparatus that performs printing on a printing medium while a head having a plurality of nozzles that discharge ink and the printing medium move relative to each other. The control program causes a computer to execute: acquiring image data to be a target of N-valued processing (N is a natural number of N≧2); acquiring input/output characteristics information showing the correspondence between input image data that is image data before N-valued processing for every line, and output image data that is image data after each piece of the input image data has been subjected to N-valued processing; correcting the image data before N-valued processing based on the input/output characteristics information acquired in the acquiring of the input/output characteristics information; performing N-valued processing on the image data corrected in the correcting of the image; converting the image data that has been subjected to N-valued processing in the N-valued processing into printing data; and executing printing based on the printing data.

According to this configuration, the same effects as those of Aspect 1 can be obtained.

Aspect 8

The printing apparatus control program of Aspect 8 is a printing apparatus control program according to Aspect 7 in which the input/output characteristics information is an N-valued input/output characteristics table that is a data table showing the correspondence between the input image data for every line and the output image data for every line, with respect to predetermined image data, and the N-valued input/output characteristics table with respect to the image data acquired by the image capturing unit is created in the acquiring of the input/output characteristics information.

According to this configuration, the same effects as those of Aspect 2 can be obtained.

Aspect 9

The printing apparatus control program of Aspect 9 is a printing apparatus control program according to Aspect 8 in which the N-valued input/output characteristics table is configured from the input image data and the output image data when, with respect to solid image data for every predetermined gray-scale level, an average pixel value for every line of each piece of the solid image data after N-valued processing is used as the output image data, and an average pixel value for every line before N-valued processing of each piece of the solid image data is used as the input image data.

According to this configuration, the same effects as those of Aspect 3 can be obtained.

Aspect 10

The printing apparatus control program of Aspect 10 is a printing apparatus control program according to Aspect 9 in which the average pixel value after N-valued processing for every line is an average value of pixel values corresponding to pixels that form a line of an image after N-valued processing, in a dot printing direction of the nozzles of the head.

According to this configuration, the same effects as those of Aspect 4 can be obtained.

Aspect 11

The printing apparatus control program of Aspect 11 is a printing apparatus control program according to any one of Aspects 8 to 10 in which, in the correcting of the image, image data of a target pixel of an image to be corrected is used as desired output image data, input image data corresponding to the desired output image data is extracted from the N-valued input/output characteristics table, and the image data of target pixels is changed into the extracted input image data.

According to this configuration, the same effects as those of Aspect 5 can be obtained.

Aspect 12

The printing apparatus control program of Aspect 12 is a printing apparatus control program according to any one of Aspects 7 to 11 in which the image data acquired in the acquiring of the image is image data after the density of the image data is corrected.

According to this configuration, the same effects as those of Aspect 6 can be obtained.

Aspect 13

According to Aspect 13 of the invention, there is provided a computer-readable recording medium on which the printing apparatus control program according to any one of Aspects 7 to 12 is recorded.

According to this configuration, it is possible to easily and reliably provide consumers, such as users, with the printing apparatus control program as set forth in any one of the above Aspects 7 to 12 by computer-readable recording media, such as CD-ROMs, DVD-ROMs, FDs, and semiconductor chips.

As a result, the same effects as those of the printing apparatus control program as set forth in any one of Aspects 7 to 12 can be obtained.

Aspect 14

According to Aspect 14 of the invention, there is provided a printing apparatus control method that is used to control a printing apparatus that performs printing on a printing medium while a head having a plurality of nozzles that discharge ink and the printing medium move relative to each other. The control method includes: acquiring image data to be a target of N-valued processing (N is a natural number of N≧2); acquiring input/output characteristics information showing the correspondence between input image data that is image data before N-valued processing for every line, and output image data that is image data after each piece of the input image data has been subjected to N-valued processing; correcting the image data before N-valued processing based on the input/output characteristics information acquired in the acquiring of the input/output characteristics information; performing N-valued processing on the image data corrected in the correcting of the image; converting the image data that has been subjected to N-valued processing in the N-valued processing into printing data; and executing printing based on the printing data.

According to this configuration, the same effects as those of Aspect 1 can be obtained.

Aspect 15

The printing apparatus control method of Aspect 15 is a printing apparatus control method according to Aspect 14 in which the input/output characteristics information is an N-valued input/output characteristics table that is a data table showing the correspondence between the input image data for every line and the output image data for every line, with respect to predetermined image data, and the N-valued input/output characteristics table with respect to the image data acquired by the image capturing unit is created in the acquiring of the input/output characteristics information.

According to this configuration, the same effects as those of Aspect 2 can be obtained.

Aspect 16

The printing apparatus control method of Aspect 16 is a printing apparatus control method according to Aspect 15 in which the N-valued input/output characteristics table is configured from the input image data and the output image data when, with respect to solid image data for every predetermined gray-scale level, an average pixel value for every line of each piece of the solid image data after N-valued processing is used as the output image data, and an average pixel value for every line before N-valued processing of each piece of the solid image data is used as the input image data.

According to this configuration, the same effects as those of Aspect 3 can be obtained.

Aspect 17

The printing apparatus control method of Aspect 17 is a printing apparatus control method according to Aspect 16 in which the average pixel value after N-valued processing for every line is an average value of pixel values corresponding to pixels that form a line of an image after N-valued processing, in a dot printing direction of the nozzles of the head.

According to this configuration, the same effects as those of Aspect 4 can be obtained.

Aspect 18

The printing apparatus control method of Aspect 18 is a printing apparatus control method according to any one of Aspects 15 to 17 in which, in the correcting of the image, image data of a target pixel of an image to be corrected is used as desired output image data, input image data corresponding to the desired output image data is extracted from the N-valued input/output characteristics table, and the image data of target pixels is changed into the extracted input image data.

According to this configuration, the same effects as those of Aspect 5 can be obtained.

Aspect 19

The printing apparatus control method of Aspect 19 is a printing apparatus control program according to any one of Aspects 14 to 18 in which the image data acquired in the acquiring of the image is image data after the density of the image data is corrected.

According to this configuration, the same effects as those of Aspect 6 can be obtained.

Aspect 20

According to Aspect 20 of the invention, there is provided an image processing device that corrects image data to be used for a printing apparatus that performs printing on a printing medium while a head having a plurality of nozzles that discharge ink and the printing medium move relative to each other. The image processing device includes: an image capturing unit that acquires image data to be a target of N-valued processing (N is a natural number of N≧2); an input/output characteristics information capturing unit that acquires input/output characteristics information showing the correspondence between input image data that is image data before N-valued processing for every line, and output image data that is image data after each piece of the input image data has been subjected to N-valued processing; and an image correcting unit that corrects the image data before N-valued processing based on the input/output characteristics information acquired by the input/output characteristics information capturing unit.

According to this configuration, the same effects as those of Aspect 1 can be obtained.

Aspect 21

The image processing device of Aspect 21 is an image processing device according to Aspect 20 in which the input/output characteristics information is an N-valued input/output characteristics table that is a data table showing the correspondence between the input image data for every line and the output image data for every line, with respect to predetermined image data, and the N-valued input/output characteristics table with respect to the image data acquired by the image capturing unit is created in the acquiring of the input/output characteristics information.

According to this configuration, the same effects as those of Aspect 2 can be obtained.

Aspect 22

The image processing device of Aspect 22 is an image processing device according to Aspect 21 in which the N-valued input/output characteristics table is configured from the input image data and the output image data when, with respect to solid image data for every predetermined gray-scale level, an average pixel value for every line of each piece of the solid image data after N-valued processing is used as the output image data, and an average pixel value for every line before N-valued processing of each piece of the solid image data is used as the input image data.

According to this configuration, the same effects as those of Aspect 3 can be obtained.

Aspect 23

The image processing device of Aspect 23 is an image processing device according to Aspect 21 in which the average pixel value after N-valued processing for every line is an average value of pixel values corresponding to pixels that form a line of an image after N-valued processing, in a dot printing direction of the nozzles of the head.

According to this configuration, the same effects as those of Aspect 4 can be obtained.

Aspect 24

The image processing device of Aspect 24 is an image processing device according to any one of Aspects 21 to 23 in which the image correcting unit uses image data of a target pixel of an image to be corrected as desired output image data, extracts input image data corresponding to the desired output image data from the N-valued input/output characteristics table and changes the image data of target pixels into the extracted input image data.

According to this configuration, the same effects as those of Aspect 5 can be obtained.

Aspect 25

The image processing device of Aspect 25 is an image processing device according to any one of Aspects 21 to 24 in which the image data acquired by the image capturing unit is image data after the density of the image data is corrected.

According to this configuration, the same effects as those of Aspect 6 can be obtained.

Aspect 26

According to Aspect 26 of the invention, there is provided an image processing program that corrects image data to be used for a printing apparatus that performs printing on a printing medium while a head having a plurality of nozzles that discharge ink and the printing medium move relative to each other. The image processing program causing a computer to execute: acquiring image data to be a target of N-valued processing (N is a natural number of N≧2); acquiring input/output characteristics information showing the correspondence between input image data that is image data before N-valued processing for every line, and output image data that is image data after each piece of the input image data has been subjected to N-valued processing; and correcting the image data before N-valued processing based on the input/output characteristics information acquired in the acquiring of the input/output characteristics information.

According to this configuration, the same effects as those of Aspect 1 can be obtained.

Aspect 27

The image processing program of Aspect 27 is an image processing program according to Aspect 26 in which the input/output characteristics information is an N-valued input/output characteristics table that is a data table showing the correspondence between the input image data for every line and the output image data for every line, with respect to predetermined image data, and the N-valued input/output characteristics table with respect to the image data acquired by the image capturing unit is created in the acquiring of the input/output characteristics information.

According to this configuration, the same effects as those of Aspect 2 can be obtained.

Aspect 28

The image processing program of Aspect 28 is an image processing program according to Aspect 27 in which the N-valued input/output characteristics table is configured from the input image data and the output image data when, with respect to solid image data for every predetermined gray-scale level, an average pixel value for every line of each piece of the solid image data after N-valued processing is used as the output image data, and an average pixel value for every line before N-valued processing of each piece of the solid image data is used as the input image data.

According to this configuration, the same effects as those of Aspect 3 can be obtained.

Aspect 29

The image processing program of Aspect 29 is an image processing program according to Aspect 28 in which the average pixel value after N-valued processing for every line is an average value of pixel values corresponding to pixels that form a line of an image after N-valued processing, in a dot printing direction of the nozzles of the head.

According to this configuration, the same effects as those of Aspect 4 can be obtained.

Aspect 30

The image processing program of Aspect 30 is an image processing program according to any one of Aspects 27 to 29 in which, in the correcting of the image, image data of a target pixel of an image to be corrected is used as desired output image data, input image data corresponding to the desired output image data is extracted from the N-valued input/output characteristics table, and the image data of target pixels is changed into the extracted input image data.

According to this configuration, the same effects as those of Aspect 5 can be obtained.

Aspect 31

The image processing program of Aspect 31 is an image processing program according to any one of Aspects 26 to 30 in which the image data acquired in the acquiring of the image is image data after the density of the image data is corrected.

According to this configuration, the same effects as those of Aspect 6 can be obtained.

Aspect 32

According to Aspect 32 of the invention, there is provided a computer-readable recording medium on which the image processing program according to any one of Aspects 25 to 31 is recorded.

According to this configuration, it is possible to easily and reliably provide consumers, such as users, with the image processing program as set forth in any one of the above Aspects 26 to 31 by computer-readable recording media, such as CD-ROMs, DVD-ROMs, FDs, and semiconductor chips.

Aspect 33

According to Aspect 33 of the invention, there is provided an image processing method that corrects image data to be used for a printing apparatus that performs printing on a printing medium while a head having a plurality of nozzles that discharge ink and the printing medium move relative to each other The image processing method includes: acquiring image data to be a target of N-valued processing (N is a natural number of N≧2); acquiring input/output characteristics information showing the correspondence between input image data that is image data before N-valued processing for every line, and output image data that is image data after each piece of the input image data has been subjected to N-valued processing; and correcting the image data before N-valued processing based on the input/output characteristics information acquired in the acquiring of the input/output characteristics information.

According to this configuration, the same effects as those of Aspect 1 can be obtained.

Aspect 34

The image processing method of Aspect 34 is an image processing method according to Aspect 33 in which the input/output characteristics information is an N-valued input/output characteristics table that is a data table showing the correspondence between the input image data for every line and the output image data for every line, with respect to predetermined image data, and the N-valued input/output characteristics table with respect to the image data acquired by the image capturing unit is created in the acquiring of the input/output characteristics information.

In the acquiring of the input/output characteristics information, the N-valued input/output characteristics table showing the correspondence between an average output luminance value after N-valued processing for every line and an input luminance value.

According to this configuration, the same effects as those of Aspect 2 can be obtained.

Aspect 35

The image processing method of Aspect 35 is an image processing method according to Aspect 34 in which the N-valued input/output characteristics table is configured from the input image data and the output image data when, with respect to solid image data for every predetermined gray-scale level, an average pixel value for every line of each piece of the solid image data after N-valued processing is used as the output image data, and an average pixel value for every line before N-valued processing of each piece of the solid image data is used as the input image data.

According to this configuration, the same effects as those of Aspect 3 can be obtained.

Aspect 36

The image processing method of Aspect 36 is an image processing method according to Aspect 35 in which the average pixel value after N-valued processing for every line is an average value of pixel values corresponding to pixels that form a line of an image after N-valued processing, in a dot printing direction of the nozzles of the head.

According to this configuration, the same effects as those of Aspect 4 can be obtained.

Aspect 37

The image processing method of Aspect 37 is an image processing method according to any one of Aspects 34 to 36 in which, in the correcting of the image, image data of a target pixel of an image to be corrected is used as desired output image data, input image data corresponding to the desired output image data is extracted from the N-valued input/output characteristics table, and the image data of target pixels is changed into the extracted input image data.

According to this configuration, the same effects as those of Aspect 5 can be obtained.

Aspect 38

The image processing method of Aspect 38 is an image processing method according to any one of Aspects 33 to 37 in which the image data acquired in the acquiring of the image is image data after the density of the image data is corrected.

According to this configuration, the same effects as those of Aspect 6 can be obtained.

### BRIEF DESCRIPTION OF THE DRAWINGS

The invention will be described with reference to the accompanying drawings, wherein like numbers reference like elements.

FIG. 1 is a block diagram showing the configuration of an image processing device according to a first embodiment of the invention.

FIG. 2 is a block diagram of a hardware configuration of a computer system used in the embodiments of the invention.

FIG. 3 is a flow chart showing the operation of the image processing device according to the first embodiment of the invention.

FIG. 4 is a schematic view showing an example of the processing order of target pixels.

FIG. 5 is a flow chart showing a method of creating an N-valued input/output characteristics table according to the first embodiment of the invention.

FIG. 6 is a schematic view showing the outline in the first embodiment of the invention.

FIG. 7 is a table showing an example of the N-valued input/output characteristics table.

FIG. 8 is a flow chart showing the operation of an image processing device according to a second embodiment of the invention.

FIG. 9 is a schematic view showing movement of a line head.

FIG. 10 is a schematic view showing an example of a recording medium on which a printing program is stored.

FIG. 11 is a view showing sums for every line of a dither matrix in the related art.

### DESCRIPTION OF EXEMPLARY EMBODIMENTS

Hereinafter, an image processing device according to embodiments of the invention will be described with reference to the accompanying drawings.

### First Embodiment

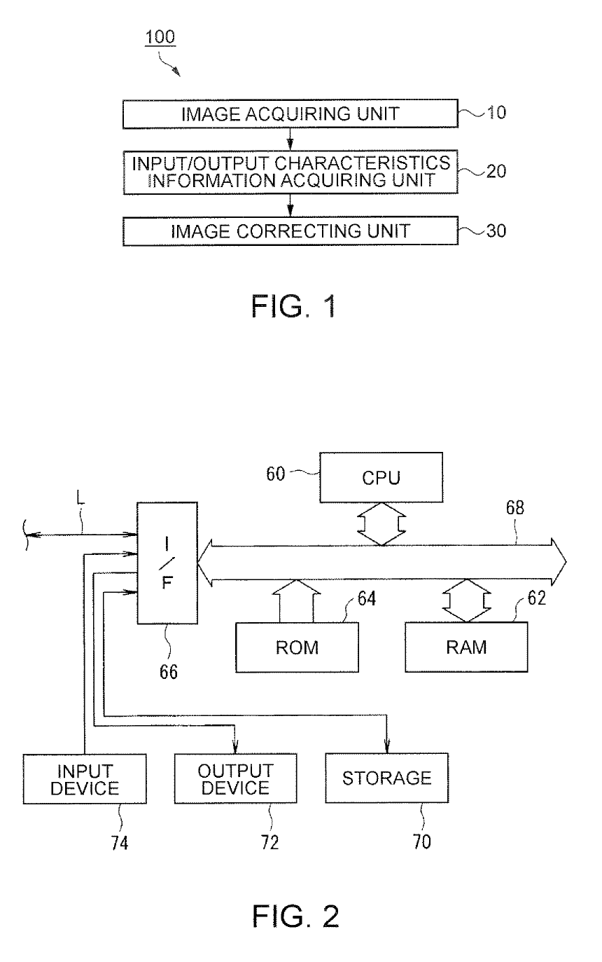

First, referring to FIGS. 1 to 7, an image processing device according to a first embodiment of the invention will be described.

FIG. 1 is a block diagram showing a configuration of the image processing device according to the first embodiment of the invention.

As shown in FIG. 1, the image processing device 100 is an image processing device 100 used in a printing apparatus that performs printing on a printing medium (printing paper, a CD-R, a DVD-R, or the like) while a head having a plurality of nozzles that discharge ink and the printing medium move relative to each other. This image processing device has an image capturing unit 10, an input/output characteristics information capturing unit 20, and an image correcting unit 30.

The image capturing unit 10 acquires image data to be a target of N-valued processing (N is a natural number of N≧2).

The input/output characteristics information capturing unit 20 acquires N-valued input/output characteristics information for every line of the image data acquired by the image capturing unit 10. In the present embodiment, the input/output characteristics information corresponds to N-valued processing techniques (contents of a dither mask) to be used for the image data acquired by the image capturing unit 10, and becomes a data table (hereinafter referred to as N-valued input/output characteristics table) showing the correspondence between an average value (hereinafter referred to as an average input luminance value) of luminance values before N-valued processing for every line of an image having a predetermined resolution, and an average value (hereinafter referred to as average output luminance value) of luminance values after N-valued processing of the input luminance value. The input/output characteristics information capturing unit 20 acquires a previously created N-valued input/output characteristics table from an external device, an internal storage, or the like, or creates an N-valued input/output characteristics table based on solid image data prepared for every predetermined gray-scale level with respect to each ink color, and an N-valued processing technique to be used.

The image correcting unit 30 corrects the image data acquired by the image capturing unit 10 based on the input/output characteristics information acquired by the input/output characteristics information capturing unit 20.

After the image data is corrected by the image correcting unit 30 of the image processing device 100, the corrected image data is subjected to N-valued processing, and further converted into printing data. Thereafter, printing is carried out by a printing apparatus, such as printer.

Next, FIG. 2 is a block diagram of a hardware configuration of a computer system to be used in the first embodiment of the invention.

The image processing device 100 includes a computer system that realizes the image capturing unit 10 that acquires image data to be a target of N-valued processing, the input/output characteristics information capturing unit 20 that acquires N-valued input/output characteristics information for every line, the image correcting unit 30 that corrects the image data based on the input/output characteristics information, etc. by a software program. The image processing device, as shown in FIG. 2, has a hardware configuration in which a CPU (Central Processing Unit) 60 that plays a role in various kinds of control and arithmetic processing, a RAM (Random Access Memory) 62 that constitutes a main storage, and a ROM (Read-Only Memory) 64 are connected to one another by various internal and external buses 68 composed of PCI (Peripheral Component Interconnect) buses and ISA (Industrial Standard Architecture) buses, and a network L for communicating with an external storage (second storage) 70, such as an HDD (Hard Disk Drive), a printing unit 22, an output device 72, such as a CRT or an LCD monitor, an input device 74, such as an operation panel, a mouse, a keyboard, or a scanner, and a printing instruction device (not shown) are connected to the buses 68 via input/output interface (I/F) 66.

When a power source is turned on, a system program, such as BIOS, which is stored in the ROM 64 or the like, loads to the RAM 62 various exclusive computer programs stored in advance in the ROM 64, or various exclusive computer programs installed in the storage 70 via a storage medium, such as a CD-ROM, a DVD-ROM, or a flexible disk (FD), or via the communication network L, such as Internet, Then, the CPU 60 performs predetermined control or arithmetic processing by making full use of various resources according to commands described in the programs loaded to the RAM 62 so that the function of each of the units as mentioned above can be realized.

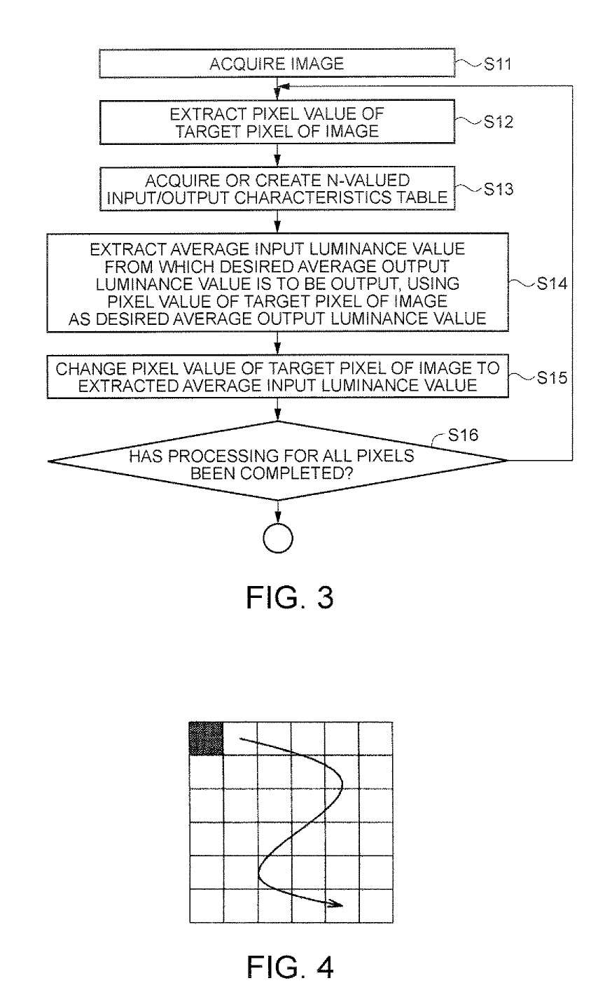

Next, referring to FIG. 3; the operation of the image processing device according to the first embodiment of the invention will be described.

First, in Step S11, the image capturing unit 10 acquires image data to be a target of N-valued processing (N is a natural number of N≧2), that is, image data desired to be subjected to N-valued processing. This image data may be acquired from the outside of the image processing device 100, or may be image data stored in the image processing device.

Next, in Step S12, the input/output characteristics information capturing unit 20 extracts image data of a target pixel of the image data acquired by the image capturing unit 10.

Next, in Step S13, the input/output characteristics information capturing unit 20 acquires an N-valued input/output characteristics table corresponding to an n-valued processing technique to be used from an external device, the storage 70, or the like, or creates an N-valued input/output characteristics table based on solid image data having predetermined gray-scale levels and the N-valued processing technique to be used (contents of a dither mask).

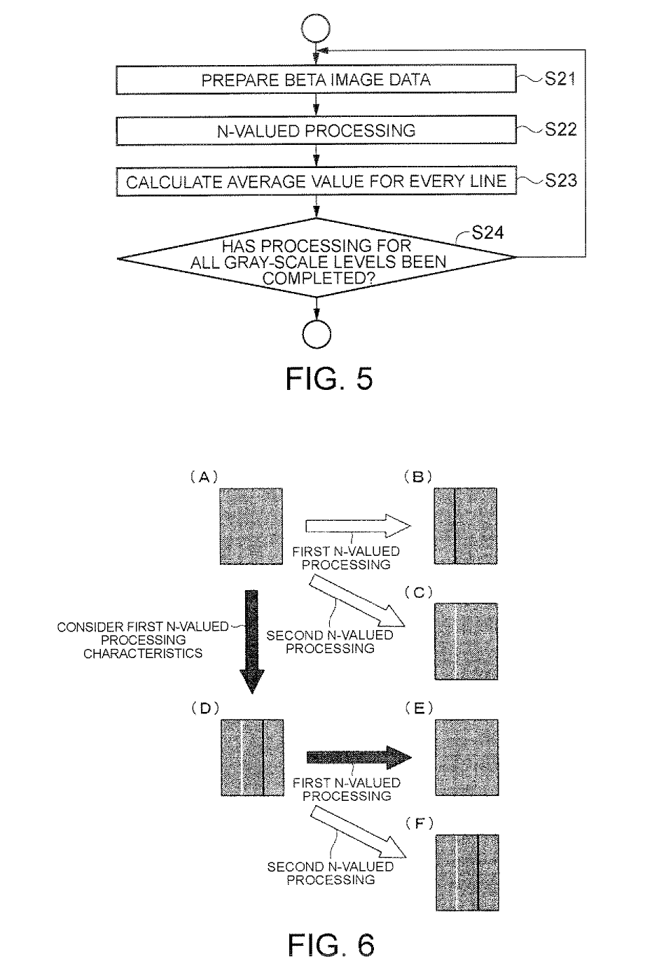

In addition, although a method of creating the N-valued input/output characteristics table will be described later referring to FIG. 5, the outline of the method is as follows. First, solid image data having predetermined gray-scale levels is prepared, the solid image data is then subjected to N-valued processing, and an average output luminance value for every line after the N-valued processing is then calculated, thereby creating an N-valued input/output characteristics table. Then, the following processing is performed referring to the N-valued input/output characteristics table.

Next, in Step S14, the image correcting unit 30 extracts an average input luminance value from which a desired average output luminance value is to be output, using the image data of the target pixel of the image acquired in Step S12 as the desired average output luminance value. As for the extraction of this average input luminance value, in a case where an average output luminance value that is the same luminance value as a target pixel value is in the N-valued input/output characteristics table, an average input luminance value corresponding to the average output luminance value is extracted directly from the table. On the other hand, in a case where a corresponding average output luminance value is not in the N-valued input/output characteristics table, the average input luminance is extracted from a near input luminance value, or is extracted by performing interpolation using neighboring values.

Next, in Step S15, the image correcting unit 30 changes the image data of the target pixel of the image acquired in Step S12 to the average input luminance value extracted in Step S14. This average input luminance value ensures that a desired output luminance value is output after N-valued processing.

Next, in Step S16, it is determined that the processing for all pixels has been completed. If any unprocessed pixels are left, the process returns to Step S12, and thereafter the processing in Steps S12 to S16 is repeated, In addition, the acquisition processing or creation processing in Step S13 may be omitted by saving an N-valued input/output characteristics table, which is acquired or created once, in the RAM 62 or the like to use the table repeatedly.

Further, when the processing for all pixels has been completed in Step S16, a series of processing is finished.

Next, referring to FIG. 4, the processing order of target pixels will be described.

FIG. 4 is a schematic view showing an example of the processing order in a case where image data of a target pixel of an image is extracted.

FIG. 4 shows a movement direction when image data of one target pixel of an image is extracted, and thereafter shift to another target pixel is made.

As shown in FIG. 4, a series of processing is performed using a colored (black) part as a target pixel of an input image, thereby extracting image data of the target pixel. Thereafter, the target pixel of the input image the extraction of which has been completed moves as indicated by the arrow in FIG. 4 from the colored part in FIG. 4. Then, a series of processing is performed using another unprocessed pixel on the right as a target pixel, thereby similarly extracting image data of the target pixel. In this way, the pixel moves in the direction indicated by the arrow. Finally, after extraction of a target pixel to a lower right on the sheet, an input image is created.

In addition, although an extraction starting pixel and an extraction ending pixel as the target pixels, and the movement direction are illustrated, the invention is not limited thereto. For example, target pixels can be extracted in various conditions.

Next, referring to FIG. 5, a method of creating an N-valued input/output characteristics table will be described.

FIG. 5 is a flow chart showing a method of creating an N-valued input/output characteristics table according to the embodiment of the invention.

The N-valued input/output characteristics table in Step S13 described referring to FIG. 3 is created according to the following procedure.

First; in Step S21, solid image data having predetermined gray-scale levels (for example, 4×256=1024 in the case of 256 gray-scale levels in four CMYK colors) is prepared.

Next, in Step 522, N-valued processing of the solid image data is performed. This N-valued processing, as mentioned above, is performed in the same conditions (for example, a dither mask having the same contents is used) for the whole solid image.

Next, in Step S23, an average input luminance value for every line before the N-valued processing of the solid image data is calculated, and an average output luminance value for every line after N-valued processing is calculated, thereby creating an N-valued input/output table as will be described later. The average output luminance value for every line is obtained by calculating an average luminance value for a line of the solid image data after N-valued processing, in a dot printing direction of nozzles in a head of a printing apparatus.

In addition, in a case where the N-valued processing method is a dither method, the N-valued input/output characteristics table can be obtained from a line sum value or a line average value of a dither mask.

Then, in Step S24, it is determined whether or not the processing for all gray-scale levels is completed. If not completed, the process proceeds to Step S21, and then the following processing is repeated. Since the processing is performed for all the gray-scale levels, the processing is repeated 256 times in total for every line, for example, in a case of an 8-bit image. In this way, after an average input luminance value and an average output luminance value for every line for the solid image data of all gray-scale levels are calculated, an N-valued input/output characteristics table is completed.

Next, referring to FIG. 6, N-valued processing of a solid image will be described.

FIG. 6 is a schematic view showing N-valued processing for creating an N-valued input/output characteristics table.

(A) in FIG. 6 is a view showing a solid image (input image), (B) in FIG. 6 is a view showing an image after first N-valued processing of the solid image, (C) in FIG. 6 is a view showing an image after second N-valued processing of the solid image, (D) in FIG. 6 is a view showing an input image created in consideration of first N-valued processing characteristics, (E) in FIG. 6 is a view showing an image after the first N-valued processing on the input image of (D) in FIG. 6, and (F) in FIG. 6 is a view showing an image after second N-valued processing of the input image of (D) in FIG. 6.

FIG. 6 is a view showing a phenomenon in a case where the solid image of (A) in FIG. 6 is subjected to N-valued processing without considering N-valued processing characteristics and a phenomenon in a case where N-valued processing characteristics are considered. That is, FIG. 6 is a view showing the outline of the first embodiment of the invention. In the following description, the first N-valued processing and the second N-valued processing are N-valued processings that are performed in different processing contents, respectively. For example, the first N-valued processing is N-valued processing using a dither technique, and the second N-valued processing is N-valued processing using an error diffusion technique. In other words, the first N-valued processing and the second N-valued processing are performed using different techniques, respectively, or performed using the same technique in different processing conditions of thresholds or the like.

First, since output average luminance for every line is different in a case where the first N-valued processing and the second N-valued processing are performed on the solid image of (A) in FIG. 6, a luminance difference occurs in a certain line in the image ((B) in FIG. 6) after the first N-valued processing, and a luminance difference occurs in a certain line even in the image ((C) in FIG. 6) after the second N-valued processing. This phenomenon occurs because average luminance of an output line is not considered.

Thus, if an image is corrected in advance before N-valued processing in consideration of characteristics of average luminance of an output line, all average luminance values are kept uniform in output. This is shown in (E) in FIG. 6. On the other hand, since the image for which first N-valued processing characteristics are considered is subjected to second N-valued processing in (F) in FIG. 6, the average luminance of an output line will differ.

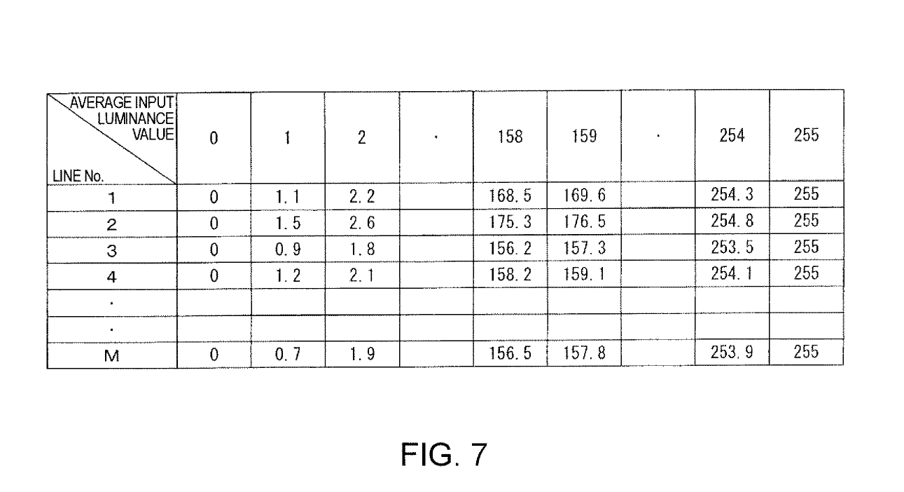

FIG. 7 is a table showing an example of the N-valued input/output characteristics table.

In FIG. 7, in a case of line No. 1, there are obtained the following results: an average output luminance value ‘0’ to an average input luminance value ‘0’; an average output luminance value ‘1.1’ to an average input luminance value ‘1’; an average output luminance value ‘2.2’ to an average input luminance value ‘2’; . . . ; an average output luminance value ‘168.5’ to an average input luminance value ‘158’; an average output luminance value ‘169.6’ to an average input luminance value ‘159’; an average output luminance value ‘254.3’ to an average input luminance value ‘254’; and an average output luminance value ‘255’ to an average input luminance value ‘255’. In a case of line No. 2, there are obtained the following results: an average output luminance value ‘0’ to an average input luminance value ‘0’; an average output luminance value ‘1.5’ to an average input luminance value ‘1’; an average output luminance value ‘2.6’ to an average input luminance value ‘2’; . . . ; an average output luminance value ‘175.3’ to an average input luminance value ‘158’; an average output luminance value ‘176.5’ to an average input luminance value ‘159’; an average output luminance value ‘254.8’ to an average input luminance value ‘254’; and an average output luminance value ‘255’ to an average input luminance value ‘255’. In a case of line No. 3, there are obtained the following results: an average output luminance value ‘0’ to an average input luminance value ‘0’; an average output luminance value ‘0.9’ to an average input luminance value ‘1’; an average output luminance value ‘1.8’ to an average input luminance value ‘2’; . . . ; an average output luminance value ‘156.2’ to an average input luminance value ‘158’; an average output luminance value ‘157.3’ to an average input luminance value ‘159’; an average output luminance value ‘253.5’ to an average input luminance value ‘254’; and an average output luminance value ‘255’ to an average input luminance value ‘255’. In a case of line No. 4, there are obtained the following results: an average output luminance value ‘0’ to an average input luminance value ‘0’; an average output luminance value ‘1.2’ to an average input luminance value ‘1’; an average output luminance value ‘2.1’ to an average input luminance value ‘2’; . . . ; an average output luminance value ‘158.2’ to an average input luminance value ‘158’, ; an average output luminance value ‘159.2’ to an average input luminance value ‘159’; an average output luminance value ‘254.1’ to an average input luminance value ‘254’; and an average output luminance value ‘255’, to an average input luminance value ‘255’. In a case of line No. M, there are obtained the following results: an average output luminance value ‘0’ to an average input luminance value ‘0’; an average output luminance value ‘0.7’ to an average input luminance value ‘1’; an average output luminance value ‘1.9’ to an average input luminance value ‘2’; . . . ; an average output luminance value ‘156.5’ to an average input luminance value ‘158’; an average output luminance value ‘157.8’ to an average input luminance value ‘159’; an average output luminance value ‘253.9’ to an average input luminance value ‘254’; and an average output luminance value ‘255’ to an average input luminance value ‘255’.

As a result, for example, if a target pixel of an input image is in a first line, and the pixel value thereof is set to ‘169’, ‘169’ becomes a desired average output luminance value. Since correction to an average input luminance value should be made such that the desired average output luminance value becomes ‘169’ in the first line. Thus, an average input luminance value whose average output luminance value is nearest to ‘169’ is extracted. That is, in line No. 1, in a case where a desired output luminance value is ‘169’, as average output luminance values closest to the desired output luminance value ‘169’, an average output luminance value ‘168.5’ corresponding to a case where an average input luminance value is ‘158’, and an average output luminance value ‘169.6’ corresponding to a case where an average input luminance value is ‘159’ are exemplified. Here, when a difference from ‘169’, is obtained, the difference in a case of the average input luminance value ‘158’ is as follows: 169−168.5=0.5, and the difference in a case of the average input luminance value ‘159’ is as follows: 169.6−169=0.6. Since the average output luminance value in the case where the average input luminance value is ‘158’ is closer to the desired output luminance value, this average input luminance value is extracted. After the average input luminance value is extracted in this manner, the image correcting unit 30 performs processing of changing the pixel data ‘169’ of the target pixel to the extracted average input luminance value ‘158’.

The above processing is performed similarly to the processing after the second line of the input image.

Accordingly, a line average input luminance value optimal for a target pixel can be obtained, and a luminance difference before and after N-valued processing can be reduced by correcting the image data of the target pixel with the line average input luminance value. Therefore, it is possible to provide an image that is cleaner and clearer than the image before correction.

### Second Embodiment

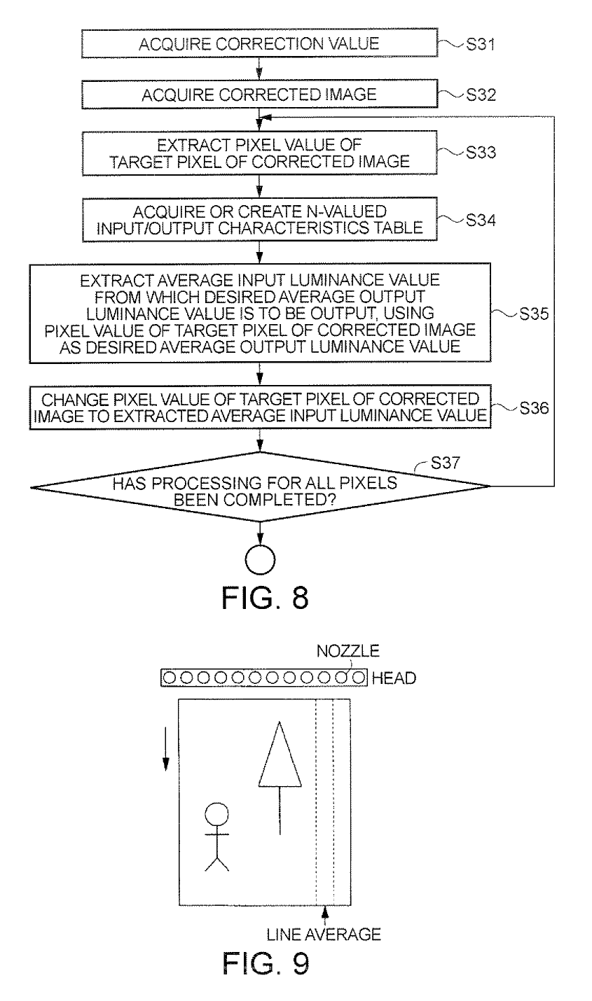

Next, referring to FIG. 8, an image processing device according to a second embodiment of the invention will be described. In addition, the other premise and configuration are the same as those of the first embodiment unless particularly specified.

FIG. 8 is a flow chart showing an operation of the image processing device according to the second embodiment of the invention.

The present embodiment is different from the above-mentioned first embodiment in that original image data is used in the first embodiment, whereas an image after being corrected with a correction value obtained by a density correction method that is generally carried out in the related art is used in the second embodiment.

First, in Step S31, the image capturing unit 10 acquires a correction value for correcting density.

Next, in Step S32, the image capturing unit 10 corrects an original image using the correction value acquired in Step S31 to acquire a corrected image. The corrected image becomes image data to be a target of N-valued processing (N is a natural number of N≧2). In addition, although the image capturing unit 10 is adapted to correct image data after the correction value is acquired, the invention is not limited thereto. For example, the image capturing unit 10 may be configured to acquire image data after correction.

Next, in Step S33, the input/output characteristics information capturing unit 20 extracts image data of a target pixel of the corrected image acquired by the image capturing unit 10.

Next, in Step S34, the input/output characteristics information capturing unit 20 acquires an N-valued input/output characteristics table corresponding to an N-valued processing technique to be used, from an external device, the storage 70, etc. or creates an N-valued input/output characteristics table based on solid image data having predetermined gray-scale levels and the N-valued processing technique to be used (contents of a dither mask). As for a method of creating the N-valued input/output characteristics table, similarly to the method described above referring to FIG. 5, solid image data having predetermined gray-scale levels is prepared first, the solid image data is then subjected to N-valued processing, and an average output luminance value for every line after the N-valued processing is then calculated, thereby creating an N-valued input/output characteristics table. Then, the following processing is performed referring to the N-valued input/output characteristics table.

Next, in Step S35, the image correcting unit 30 extracts an average input luminance value from which a desired average output luminance value is to be output, using the image data of the target pixel of the corrected image acquired in Step S32 as the desired average output luminance value, from the N-valued input/output characteristics table.

Next, in Step S36, the image correcting unit 30 changes the image data of the target pixel of the image acquired in Step S33 to the average input luminance value extracted in Step S35. This average input luminance value ensures that the desired average output luminance value is output after N-valued processing.

Next, in Step S37, it is determined that the processing for all pixels has been completed. If any unprocessed pixels are left, the process returns to the above-described Step S33, and thereafter Steps S33 to S37 are repeated.

Then, when the processing for all pixels has been completed in Step S37, a series of processing is finished.

According to the present embodiment, a line average input luminance value optimal for a target pixel value after density correction can be obtained, and a luminance difference before and after N-valued processing can be reduced by correcting the image data of the target pixel with the line average input luminance value. Accordingly/since the density correction effect is further promoted, it is possible to provide cleaner and clearer image.

Although the embodiments of the invention have been described hitherto, a case where the invention is used for, specifically, a line head printer will be described.

FIG. 9 is a schematic view showing movement of a line head.

A line head printer has, particularly, a fixed printing head (one-pass printing) and a much larger number of nozzles than a multi-pass printer. Therefore, the line head printer is adapted to raise or lower the density in units of nozzles, thereby keeping the density after printing uniform. However, if outputs for every line are different, an output difference (a difference between an average density value (or a luminance value) before N-valued processing and an average density value (or a luminance value) after N-valued processing) for every line has a bad effect on printing quality. For example, there is a case that reversal of gray-scale may be caused in printing of an image whose density changes by stages and by gray-scale, like a gradation image. In this case, the line direction that becomes most important in applying the invention, as shown in FIG. 9, is a direction perpendicular to a nozzle arrangement direction (dot printing direction of nozzles) of a line head, that is, a part indicated by a dotted line in the figure. By using this part as a line average luminance value, an N-valued input/output characteristics table is created. As a result, an optimal line average value can be obtained.

In addition, although the above embodiments have been described about the case where the control programs stored in advance in the ROM 64 are executed when carrying out the processing shown in the flow charts of FIGS. 3, 5 and 8, the invention is not limited thereto. For example, a program showing the sequence of the above processing may be incorporated into and executed in the RAM 62 from a storage medium on which the program is recorded. Alternatively, the program may be acquired from networks.

Here, the storage medium includes all kinds of storage media, including semiconductor storage media, such as RAMs and ROMs, magneto-optical storage media, such as FDs and HDs, optically-readable storage media, such as CDs, CDVs, LDs, and DVDs, and magneto-optical/optically-readable storage media, such as MOs, as long as they are computer-readable storage media irrespective of using any one of electronic, magnetic, and optical reading methods.

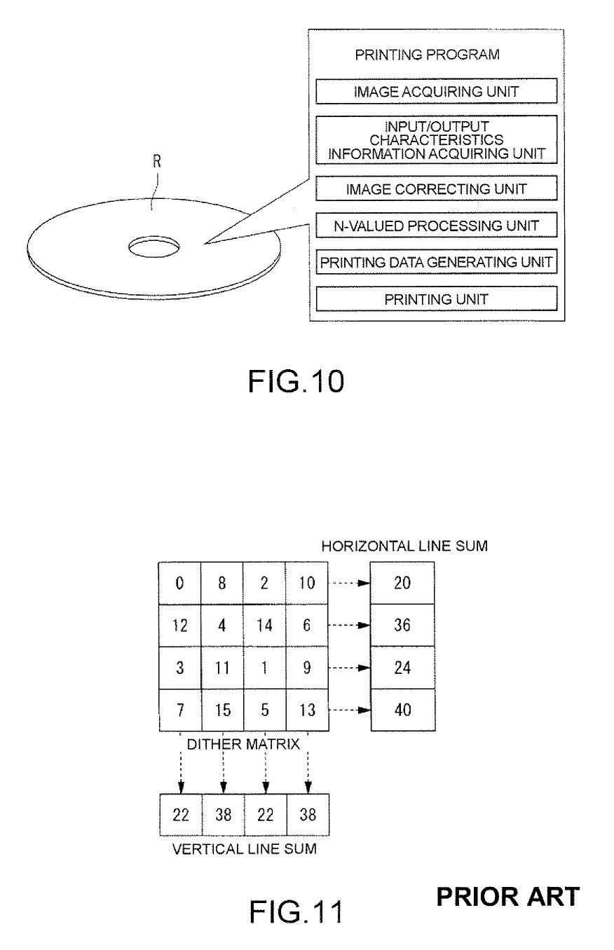

FIG. 10 is a schematic view showing an example of a recording medium on which the printing program of the embodiment of the invention is stored.

This recording medium stores a printing apparatus control program that controls a printing apparatus that performs printing on the printing medium while a head having a plurality of nozzles that discharge ink and a printing medium move relative to each other. This program causes a computer to execute the processing to be realized as an image capturing unit that acquires image data to be a target of N-valued processing (N is a natural number of N≧2), an input/output characteristics information capturing unit that acquires N-valued input/output characteristics information for every line, an image correcting unit that corrects the image data based on the input/output characteristics information acquired by the input/output characteristics information capturing unit, an N-valued processing unit that performs N-valued processing on the image data corrected by the image correcting unit, a printing data creating unit that coverts the image data subjected to the N-valued processing by the N-valued processing unit into printing data, and a printing unit that executes printing based on the printing data.

Although the embodiments of the invention have been described hitherto, the invention is not limited thereto, and various changes may be made without departing from the scope of the invention

For example, in the above embodiments, average luminance (average output luminance) for every line is obtained by calculating an average luminance value for every line after N-valued processing of solid image data in creating an N-valued input/output characteristics table, but the invention is not limited thereto. In a case where the N-valued processing method is a dither method, the output luminance can be obtained from a line sum value or a line average value of a dither matrix. In this case, a line characteristics table will be created.

Further, in the above embodiments, the N-valued input/output characteristics table is created based on an average output luminance value for every line, but the invention is not limited thereto. For example, an N-valued input/output characteristics table can be created based on an average output luminance value for every line group. Otherwise, when a printing apparatus except for the line head printer is used, an N-valued input/output characteristics table can be created for every group determined according to prescribed rules rather than for every line.

What is claimed is:

1. A printing apparatus that performs printing on a printing medium while a head having a plurality of nozzles that discharge ink and the printing medium move relative to each other, the apparatus comprising:
an image capturing unit that acquires image data to be a target of N-valued processing (N is a natural number of N≧2);
an input/output characteristics information capturing unit that acquires input/output characteristics information showing a correspondence between input image data that is image data before N-valued processing for every line, and output image data that is image data after each piece of the input image data has been subjected to N-valued processing;
an image correcting unit that corrects the image data before N-valued processing based on the input/output characteristics information acquired by the input/output characteristics information capturing unit;
an N-valued processing unit that performs N-valued processing on the image data corrected by the image correcting unit;
a printing data creating unit that converts the image data that has been subjected to N-valued processing by the N-valued processing unit into printing data; and
a printing unit that executes printing based on the printing data.

2. The printing apparatus according to claim 1,
wherein the input/output characteristics information comprises an N-valued input/output characteristics table that is a data table showing a correspondence between the input image data for every line and the output image data for every line, with respect to predetermined image data, and
wherein the input/output characteristics information capturing unit creates the N-valued input/output characteristics table with respect to the image data acquired by the image capturing unit.

3. The printing apparatus according to claim 2,
wherein the N-valued input/output characteristics table is configured from the input image data and the output image data if, with respect to solid image data for every predetermined gray-scale level, an average pixel value for every line of each piece of the solid image data after N-valued processing is used as the output image data, and an average pixel value for every line before N-valued processing of each piece of the solid image data is used as the input image data.

4. The printing apparatus according to claim 3,
wherein the average pixel value after N-valued processing for every line comprises an average value of pixel values corresponding to pixels that form a line of an image after N-valued processing, in a dot printing direction of the nozzles of the head.

5. The printing apparatus according to claim 2,
wherein the image correcting unit uses image data of a target pixel of an image to be corrected as desired output image data, extracts input image data corresponding to the desired output image data from the N-valued input/output characteristics table and changes the image data of target pixels into the extracted input image data.

6. The printing apparatus according to claim 1,
wherein the image data of an image to be corrected that is acquired by the image capturing unit comprises image data after a density of the image data is corrected.

7. A printing apparatus control method that controls a printing apparatus that performs printing on a printing medium while a head having a plurality of nozzles that discharge ink and the printing medium move relative to each other, the control method comprising:
acquiring image data to be a target of N-valued processing (N is a natural number of N≧2);
acquiring input/output characteristics information showing a correspondence between input image data that is image data before N-valued processing for every line, and output image data that is image data after each piece of the input image data has been subjected to N-valued processing;
correcting the image data before N-valued processing based on the input/output characteristics information acquired in the acquiring of the input/output characteristics information;
performing N-valued processing on the image data corrected in the correcting of the image;
converting the image data that has been subjected to N-valued processing in the N-valued processing into printing data; and
executing printing based on the printing data.

8. The method of claim 7 wherein the method further comprises a printing apparatus control program that causes a computer to execute the method steps.

9. A computer-readable recording medium on which the printing apparatus control program according to claim 8 is recorded.

10. An image processing device that corrects image data to be used for a printing apparatus that performs printing on a printing medium while a head having a plurality of nozzles that discharge ink and the printing medium move relative to each other, the image processing device comprising:
an image capturing unit that acquires image data to be a target of N-valued processing (N is a natural number of N≧2);
an input/output characteristics information capturing unit that acquires input/output characteristics information showing a correspondence between input image data that is image data before N-valued processing for every line, and output image data that is image data after each piece of the input image data has been subjected to N-valued processing; and
an image correcting unit that corrects the image data before N-valued processing based on the input/output characteristics information acquired by the input/output characteristics information capturing unit.

11. An image processing method that corrects image data to be used for a printing apparatus that performs printing on a printing medium while a head having a plurality of nozzles that discharge ink and the printing medium move relative to each other, the image processing method comprising:
acquiring image data to be a target of N-valued processing (N is a natural number of N≧2);
acquiring input/output characteristics information showing a correspondence between input image data that is image data before N-valued processing for every line, and output image data that is image data after each piece of the input image data has been subjected to N-valued processing; and
correcting the image data before N-valued processing based on the input/output characteristics information acquired in the acquiring of the input/output characteristics information.

12. The method of claim 11 wherein the method further comprises an image processing program that causes a computer to execute the method steps.

13. A computer-readable recording medium on which the image processing program according to claim 12 is stored.
